(19) United States
(12) Patent Application Publication
(10) Pub. No.: US 2009/0320007 A1
(43) Pub. Date: Dec. 24, 2009

(54) LOCAL METADATA FOR EXTERNAL COMPONENTS

(75) Inventors: Raja Krishnaswamy, Redmond, WA (US); Shrikrishna V. Borde, Redmond, WA (US); Michael Shneerson, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/144,743

(22) Filed: Jun. 24, 2008

(51) Int. Cl. G06F 9/45

(52) U.S. Cl. 717/151

(57) ABSTRACT

A system and method for facilitating execution of a computer program in a framework, in which the computer program uses a component external to the framework is provided. The computer program is generated by compiling corresponding source code to produce generated code, extracting metadata corresponding to the external component, and combining the generated code with the metadata. The extracted metadata may be a partial subset of the metadata corresponding to the external component. When the computer program is executed, the combined metadata may be used to invoke or otherwise interact with the external component.

### CROSS-REFERENCE TO RELATED APPLICATIONS

The present invention is related to U.S. patent application entitled “Unified Metadata For External Components,” Ser. No. ______, filed concurrently herewith, the contents of which are hereby incorporated by reference herein.

### TECHNICAL FIELD

The present invention relates generally to computer systems, and, more particularly, to the interoperation of software components between platforms.

### BACKGROUND

Computer programs typically are made up of components called objects. An object may include both computer instructions and data. Objects of a program may invoke other objects within the program, or external components. An object may be designed to be used as an external component by a program, or by multiple programs. An object may be designed with a defined set of methods and data types, and perform in defined ways, to facilitate use by a variety of programs and programmers. An interface defines access to the object's public methods and data, including the behavior of the methods. With a well-defined interface, an object may be changed and continue to work for programs that invoke it, provided it conforms to the interface.

The Component Object Model (COM), produced by Microsoft Corporation of Redmond, Wash., is a software architecture for creating, communicating with, and using objects. A COM object may have one or more interfaces that expose its attributes and functionality to external components or applications. A software developer may use a COM object without needing to know many of the details of its implementation, and can rely on the interface even if the implementation changes in a future version. The COM architecture allows an object written in a programming language to be used by programs written in different programming languages. A developer of the other programs need not even know the language of the COM object.

A COM interface is a strongly-typed contract between the object and external programs. Each interface has a unique identifier, referred to as a globally unique identifier (GUID). If a COM object implements more than one interface, each interface has its own unique GUID. A GUID is typically a 128-bit integer number. A GUID facilitates correct connection between a COM object and a calling program. If a COM object is updated and requires one or more updated interfaces, each new one has a new corresponding GUID. According to the COM protocol, each new interface must be compatible with previous interfaces. They may add new methods or definitions, but do not change or delete older definitions.

A framework is a software architecture that facilitates sharing of services to applications that run within the framework. For example, a framework may provide services such as memory allocation and deallocation, user interface, exception handling, network communications, managing the lifetime of processes, or other such services. This type of framework may be referred to as a “managed framework,” and programs that execute within such a framework may be referred to as “managed programs.” The .NET framework, by Microsoft Corporation, is an example of such a framework. It provides a framework for application development and execution. The .NET framework includes a runtime environment known as the Common Language Runtime (CLR). The CLR manages programs within the framework, by locating and loading classes, handling references to objects and their methods, allocating and deallocating memory, and other runtime services. A framework may enable a software developer to develop programs using the framework as a platform, facilitating deployment on a variety of different computer systems.

To facilitate use of a COM object from a program in the .NET framework, an interop assembly may be used. An interop assembly is a bridging system that enables interaction between software objects across different architectures, such as the managed architecture of .NET and the unmanaged COM architecture. An interop assembly generally includes metadata that enables interaction between software objects. The metadata of an interop assembly corresponding to a COM object generally includes the interface definitions as well as other metadata that is exposed by the COM object and used by a managed program. The framework can use the metadata of an interop assembly to enable a managed program to use a COM object in a manner similar to using a managed component.

FIG. 1A illustrates a compile-time environment 100 having components from two different architectures. COM component 104 is a component that adheres to the COM architecture. COM component 104 is not a part of compile-time environment 100. It is shown in dashed lines to indicate a relation to compile time environment 100. Specifically, COM component 104 may be used as input to generate interop assembly 106 prior to compilation of application source code 110. As shown in FIG. 1B, COM component 104 may also be used at runtime.

Framework 108a is a platform with an architecture that facilitates and manages execution of programs or subprograms, and further facilitates compilation of programs to be managed. Application source code 110 is source code that is translated by compiler 112 into a managed application 114 that runs within framework 108. Compiler 112 receives as input application source code 110 and interop assembly 106, generating managed application 114.

FIG. 1B illustrates a runtime environment 101, corresponding to compile-time environment 100 of FIG. 1. Runtime environment 101 includes components from two different architectures. As discussed above, COM component 104 is a component that adheres to the COM architecture. It may be used by one or more computer programs, including programs within framework 108b and programs external to framework 108b. It has an associated VTable 120. Briefly, VTable 120 includes data that facilitates dynamic access to objects, methods, or data during runtime, by providing pointers. For example, VTable 120 may have a table with an entry for each method of the COM component. When an external component needs to invoke a method, it may retrieve, from the VTable, a pointer to the method, and use the pointer to reference the method.

Framework 108b is an architecture that facilitates and manages execution of programs or subprograms. It presents a different view of framework 108a of FIG. 1. Managed application 114 is a managed application that runs within framework 108b. Runtime manager 118 provides services to managed application 114, as discussed above. Runtime manager 118 receives metadata from interop assembly 106 and vtable 120 to facilitate referencing COM component 104.

Interop assembly 106 enables managed application 114 to invoke and use COM component 104. As discussed above, interop assembly 106 includes metadata, such as interface definitions, exposed by COM component 104. When managed application 114 invokes a method of COM component 104, interop assembly 106 may be used to locate and invoke the method. Runtime manager 118 may retrieve a pointer to the method from VTable 120.

In runtime environment 101, prior to executing managed application 114, or at least prior to the use of COM component 104 by manage application 114, interop assembly 106 is deployed, so that it may be used as discussed herein. There may be added complexity in a situation in which there are multiple versions of interop assembly 106, with respect to deploying a correct interop assembly. Further, interop assembly can be large, and deployment or runtime use can use up valuable storage or memory.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, a system, method, and components operate to generate and execute a computer program in a framework that accesses a component outside of the framework. A program generator retrieves metadata from an assembly associated with the external component and combines the metadata with the computer program so that the metadata has a scope that is local to the computer program. At run time, the program may reference the external component by using the merged metadata. The program does not need to reference the assembly at run time.

A system may include a compiler that translates source code of the computer program into compiled code. The compiled code may be a machine code, an interpretable code, or an intermediate code. In one aspect of the mechanisms, the compiler may determine a set of methods of the external component referenced by the computer program, and the program generator may use the determined set to determine the metadata to be extracted and combined with the program.

One aspect of the system is determining a minimal reference set of methods or type definitions based on the computer program. Metadata corresponding to the reference set may be included with the computer program. Metadata corresponding to methods or type definitions that are not referenced by the computer program may be excluded from the computer program. One feature of the minimal reference set is that it is sufficient to enable the computer program to execute in a system in which the assembly is not deployed. It may be greatly reduced in size from the entire metadata of the assembly. The assembly may have been generated from the external component prior to the actions of extracting metadata from the assembly.

In one aspect of the invention, a runtime manager may detect references to the external component, and perform actions to facilitate invocations of the external component. The runtime manager may retrieve metadata from the computer program and generate a types object that includes metadata to be used during runtime. The types object may also have program instructions to facilitate invoking external component methods, such as code to marshal arguments.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1A-B show a compile-time system and a run-time system enabling objects from two different architectures to interact;

FIGS. 2A-B show one embodiment of a compile-time system and a run-time system enabling objects from two different architectures to interact, in accordance with mechanisms described herein;

FIGS. 3A-C show one embodiment of a compile-time system and a run-time system enabling a computer program in a framework to interact with different versions of an external component, in accordance with mechanisms described herein;

FIG. 4 show components of a compile-time system in which metadata is selectively used, in accordance with an embodiment of the mechanisms described herein;

FIG. 5 is a logical flow diagram generally showing a process of generating a computer program, in accordance with an embodiment of the present invention; and

FIG. 6 is a logical flow diagram generally showing a process of facilitating an interaction of external components with a computer program, in accordance with an embodiment of the present invention.

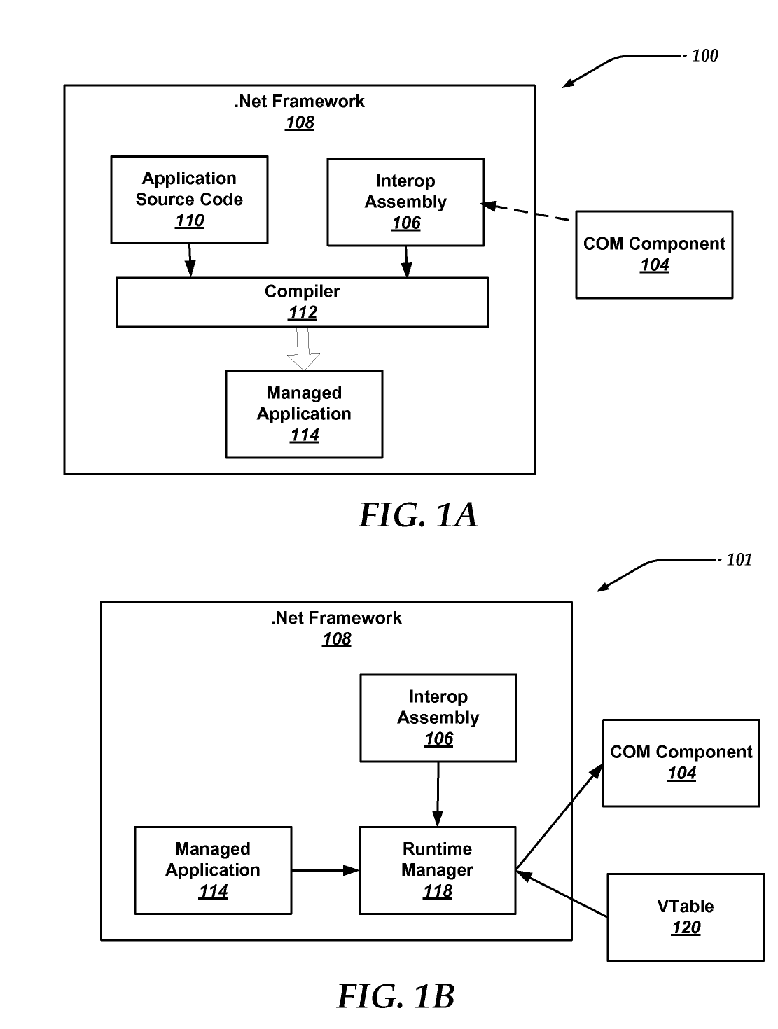

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. Similarly, the phrase “in one implementation” as used herein does not necessarily refer to the same implementation, though it may.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The components may execute from various computer readable media having various data structures thereon. The components may communicate via local or remote processes such as in accordance with a signal having one or more data packets (e.g. data from one component interacting with another component in a local system, distributed system, or across a network such as the Internet with other systems via the signal). Computer components may be stored, for example, on computer readable media including, but not limited to, an application specific integrated circuit (ASIC), compact disk (CD), digital versatile disk (DVD), read only memory (ROM), floppy disk, hard disk, electrically erasable programmable read only memory (EEPROM), flash memory, or a memory stick in accordance with embodiments of the present invention.

As used herein, the term “method” refers to a portion of code, associated with a class or an object, that performs a specific task, and can execute relatively independently of other methods. A method may, but does not necessarily, return a value. As used herein, the term method includes functions, procedures, or a subroutines.

A computer program refers to computer instructions representing logic for performing actions. A computer program may also include data. A computer program may have one or more representations, including source code and compiled code. A computer program may have one or more representations of compiled code, in that source code may be compiled to produce an intermediate compiled code which may be further compiled to produce executable code or other intermediate compiled code.

An application executable is a data object that includes program instructions, typically in a binary formatted file. Generally, the program instructions are a machine code and correspond to processor instructions, though the program instructions may be in another format that is emulated by a processing system. An application executable may include various types of data related to program instructions, such as symbols, debugging information, exception information, strings, resources or the like. A compilation system may produce a single executable file, or it may produce a primary executable file, one or more library files, or associated resource files. As used herein, the term application executable may include one or more executable files, associated files, or a combination thereof. An application executable may also be one or more memory blocks, objects in a database, or other forms of data. An application executable is a representation of a computer program.

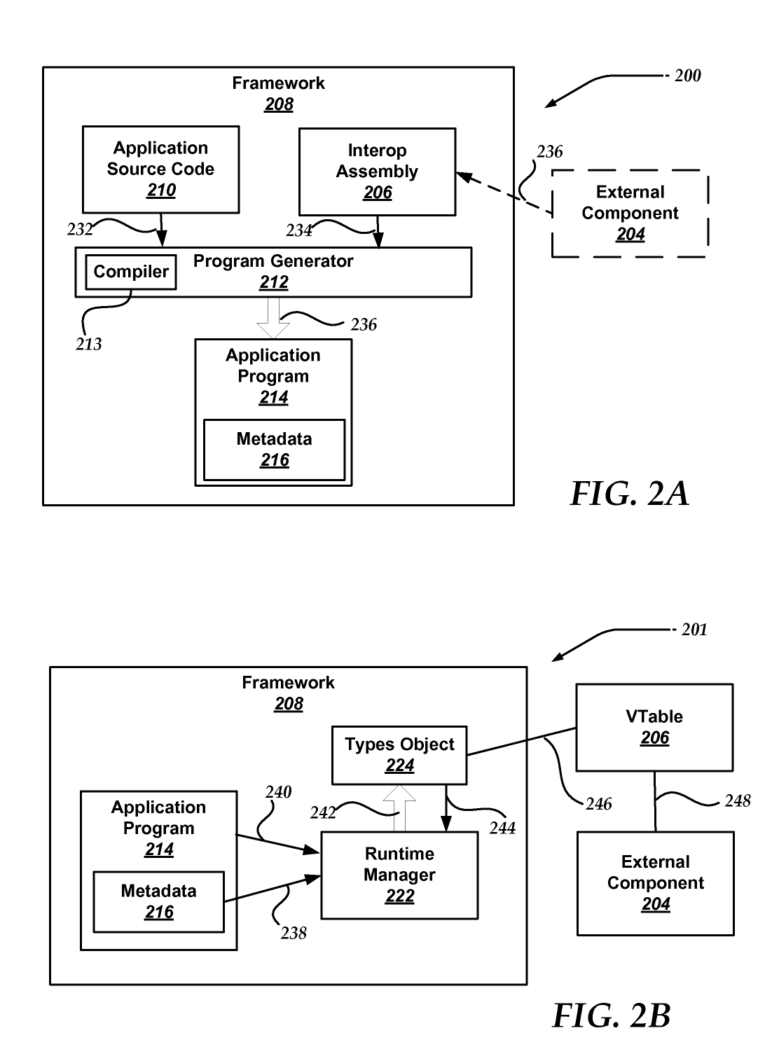

FIG. 2A is a block diagram of a compile-time system 200 in which an embodiment of the present invention may be employed. Framework 208 is an architecture that facilitates compilation and execution of programs or subprograms. Framework 208 may be an architecture such as the .NET Framework, by Microsoft Corporation, of Redmond, Wash., though mechanisms described herein are not so limited. In the illustrated embodiment, framework 208 includes interop assembly 206 and program generator 212. Interop assembly 206 includes metadata, such as type definitions, exposed by external component 204. Interop assembly 206 may include one or more files. External component 204 is a software component that is outside of the framework 108. It may, for example, adhere to the COM architecture, though it is not so limited. It may include one or more classes or objects, each having one or more methods. Interop assembly may employ a mechanism for authentication, such as a digital signature indicative of the provider of the assembly. External component 204 is not a part of the compile-time environment 200, but is shown in dashed lines to indicate a relation to compile time environment 200. External component 204 may be used as input by an external component compiler (not shown) to generate interop assembly 206 prior to compilation of application source code 210. Line 230 indicates that interop assembly 206 is derived from external component 204. As shown in FIG. 2B, external component 204 may also be used at runtime.

The metadata of interop assembly 206 may include type definitions and other data that may be used by program generator 212 to enable compilation of source code that references methods or data of external component 204. The metadata may also include data that may be used during runtime for enabling an application to invoke or reference external component 204. At least a portion of the metadata may represent an external interface corresponding to external component 204.

Application source code 210 includes source code of an application or subprogram, or a portion thereof. Application source code may include one or more files. Program generator 212 may be used to translate application source code 210 into an executable application program or subprogram. A subprogram may be a library, such as a dynamic linked library or other type of program library. Application program 214 may be such an application program or subprogram. As used herein, application program or computer program may refer to a computer program, subprogram, library, dynamic linked library, or other such units of computer programs. Program generator 212 may have logic for compiling a specific high level source language, such as C#, C++, Visual Basic, Java, or the like. In one embodiment, program generator 212 may have logic for compiling an intermediate language. It may include a front end compiler that partially compiles a high level language, or it may receive an intermediate language from another component not shown in FIG. 2A.

Program generator 212 may include various subcomponents, such as a front end, a back end, an optimizer, an assembler, a linker, or the like. These subcomponents are represented in FIG. 2 by compiler 213. It may produce various intermediate files or data objects prior to generating application program 214. It may also retrieve and include various other files or data as part of its compilation actions.

In one embodiment, program generator 212 may perform actions to translate application source code 210 into compiled code to be included in application program 214. This may include various actions of a compiler, such as lexical analysis, syntactic analysis, semantic analysis, code generation, and code optimization, as well as linking code with code received from other components. The compiled code may be in a binary format with instructions native to a computer processor. Compiled code may be an intermediate language. In one embodiment, an intermediate language code may be further compiled immediately prior to execution.

In one embodiment, program generator 212 may determine external components that are referenced by application source code 210. It may further determine methods or data exposed by the referenced external components. For example, program generator 212 may determine, based on the content of application source code 210, that external component 204 is referenced. It may further determine a set of methods or data of component 204 that are referenced or otherwise needed by application program 214. In one embodiment, compiler 213 may flag methods or other references to external objects that are to be included in the set of methods or data for which corresponding metadata is to be retrieved. Program generator 212 may then use this information as discussed herein.

Program generator 212 may use the reference information to determine interop assemblies that are associated with the referenced external components. In the illustrated example, program generator 212 may determine that interop assembly 206 is associated with external component 204, which is referenced by application program 214.

Program generator 212 may extract, from interop assembly 206, metadata corresponding to external component 204, and merge the metadata into application program 214. In one embodiment, program generator 212 may employ services provided by the framework for accessing metadata of interop assembly 206. For example, the Microsoft .NET framework includes a set of reflection procedures that enable programmatic access to the metadata or other content of an assembly.

In one embodiment, a subset of the metadata that resides within interop assembly 206 is extracted and merged, wherein the subset includes a set of metadata corresponding to methods or data that are referenced by application program 214, or are otherwise needed by application program 214. In one embodiment, program generator 212 may determine a minimal set of metadata to extract and merge, based on references in the application source code 210. For each method referenced, program generator 212 may include metadata related to the method's signature. The signature of a method includes data such as the name of the method, the number, types, and order of its parameters, and the method's return type. The minimal set may exclude metadata corresponding to methods or data types that are not referenced by application source code 210. In one implementation, the excluded data may be represented in the embedded data by stubs, in order to maintain an accurate correspondence with referenced methods. For example, if application source code 210 references one method of external component 204, the minimal subset may include metadata corresponding to the referenced method, including input arguments and return values. As illustrated in FIG. 2A, application program 214 generated by program generator 212 includes metadata 216 that has been extracted and merged with the application program 214. The metadata 216 may include information that is sufficient to enable application program 214 or runtime manager 222 to instantiate external component 204, invoke any methods, or reference any data types of external component 204.

In one implementation, the metadata 216 is a local view of the metadata or, it may be said, the metadata is “local” to the application program 214. That is, it has a local scope such that it is only available for direct reference by the application program 214 in which it is embedded. Though not illustrated in FIGS. 2A or 2B, in a configuration in which a second application program references external component 204, the program generator may retrieve metadata from interop assembly 206 and embed it into the second application program, so that the second application program has its own local copy of the metadata. Depending on the particular references of the second program, its embedded metadata may be the same as or different from the embedded metadata 216 of the illustrated application program 214. Arrows 232 and 234 indicate that program generator 212 receives application source code 210 and interop assembly 206, respectively, as input. Arrow 236 indicates that program generator 212 generates application program 214, including metadata 216.

Interop assembly 206 may include program instructions in the form of source code or compiled code for facilitating invocation of external component 204. These may include, for example, instructions for marshalling method parameters, enabling return values, managing the call stack, or other operations. In accordance with the mechanisms described herein, it is not necessary to include these program instructions in application program 214. Thus, in one embodiment, program instructions from interop assembly 206 are not combined with the metadata 216 into application program 214. In one embodiment, program instructions from interop assembly 206 may be combined with metadata 216 into application program 214.

FIG. 2B is a block diagram of a runtime system 201, in which an embodiment of the present invention may be employed. Runtime system 201 corresponds to compile time system 200, and illustrates a runtime system that may exist subsequent to operation of the compilation system illustrated in FIG. 2A. Like numbered components in FIG. 2B represent like numbered components of FIG. 2A, and the discussion of these components with reference to FIG. 2A applies to FIG. 2B, unless indicated otherwise herein. Runtime system 201 and compile-time system 200 may be considered to be subsystems of a system for development and execution of computer programs.

Typically, runtime system 201 exists on a different computer system than compile-time system 200. Compile-time system 200 may be used with a development computer system, wherein runtime system 201 may be used with an end user computer system or a server computer system. The computer system of compile time system 200 may include various development tools, source code, and components such as interop assembly 206. The computer system of runtime system 201 typically does not have interop assembly 206 as well as other development tools and source code. In some embodiments, runtime system 201 may include the additional components of compile-time system 200. This may be the case, for example, during development and testing of programs.

As illustrated, runtime system 201 includes runtime manager 222. Runtime manager 222 includes one or more components that provide services for and manage the execution of, application program 214. This may include locating and loading class objects, handling references to objects and their methods, allocating memory, handling exceptions, managing security, or other runtime services. Arrow 240 illustrates that runtime manager 222 may receive various data or invocations from application program 214 during execution of application program 214.

In one implementation, runtime manager 222 may retrieve data (as shown by arrow 238) from metadata 216 and generate (as shown by arrow 242) a corresponding types object 224 with the data or a transformation thereof. Runtime manager 222 may also generate code and add the generated code to types object 224. This may include code to facilitate invocation of methods, such as instructions that marshal arguments, manipulate a runtime stack, store or retrieve data to or from registers, or the like. Each application program may have a corresponding types object. Runtime manager 222 may use types object 224 to facilitate interaction with external component 204. External component 204 may be used by one or more computer programs, including programs within framework 208 or programs external to framework 208.

During execution of application program 214, execution may reach a reference to external component 204. The reference may be an instantiation of an object or an invocation of a method. In response, runtime manager 222 may retrieve data (arrow 244) from types object 224 as needed to perform the desired operation. Runtime manager 222 may employ the retrieved data to perform the operation or pass control to types object 224 to perform operations facilitating interaction with external component 204. For example, invocation of a method may cause types object 224 to marshal arguments to be passed to the method, retrieve a pointer to the method within external component 204, and invoke the method. When the invoked method exits, types object 224 may process a returned value to facilitate handling by the calling program. In some implementations, runtime manager 222 may perform at least a portion of these actions.

Types object 224 may facilitate retrieving a pointer to the method within external component. In one implementation, types object may maintain references into vtable 206 (as shown by line 246), while vtable 206 maintains references into external component 204 (as shown by line 248). Upon request by runtime manager 222, types object may use these two levels of references to obtain a pointer into external component 204 and pass the pointer (as shown by arrow 244) to runtime manager 222.

It is to be noted that interop assembly 206 of FIG. 2A is excluded from FIG. 2B. In the illustrated embodiment, runtime references to external component 204 by application program 214 are handled without the use of interop assembly 206. The execution of application program 214 and external component 204 may be performed without having interop assembly installed on the host computer. Types object 224, which facilitates interaction with external component 204, may be generated by runtime manager 222 during execution of application program 214. Therefore, runtime system 201 does not need to have types object 224 deployed prior to or during execution of application program 214.

Compile-time system 200 and runtime system 201 are only examples of suitable systems and are not intended to suggest any limitation as to the scope of use or functionality of the present invention. Thus, a variety of system configurations may be employed without departing from the scope or spirit of the present invention. The components of compile-time system 200 and runtime system 201 are presented to show functional or logical aspects of the respective systems. However, these logical components may be implemented in a variety of ways. They may be implemented as separate software components or hardware and software combinations, integrated into a single component, or physically divided in a number of ways. Reference to each component herein refers to a logical component and includes the various configurations that may be used to implement the functionality discussed. They may be implemented on a single computing device or distributed among multiple computing devices in a variety of configurations.

A computing device may be a special purpose or general purpose computing device. Example computing devices include personal computers, portable computers, telephones, PDAs, servers, mainframes, consumer electronics, or the like. In brief, one embodiment of a computing device that may be employed includes one or more central processing units, a video display adapter, and a mass memory, all in communication with each other via a bus. Each processor may employ a chip multi-processing architecture (CMP), a symmetric multi-threading (SMT) architecture, or a chip multi-threading (CMT) architecture. Briefly, CMP refers to a processor architecture in which there are multiple processor cores per processor chip. SMT refers to a processor architecture in which a processor core has multiple hardware threads of execution. CMT refers to a processor architecture having multiple processor cores per processor chip and multiple hardware threads of execution per core.

The mass memory may include a random access memory (RAM), a read only memory (ROM), one or more permanent mass storage devices, removable media, or a combination thereof. Mass storage devices may include a hard disk drive, optical drive, flash memory, or a floppy disk drive. The mass memory may include a general-purpose operating system, application programs, security programs, communication programs, or other computer programs.

In a system including multiple computing devices, the computing devices may be directly connected or connected through a network, such as a local area network (LAN), wide area network (WAN), or other type of network. Each computing device may include a network interface component, modem, or other components for communicating with other computing devices.

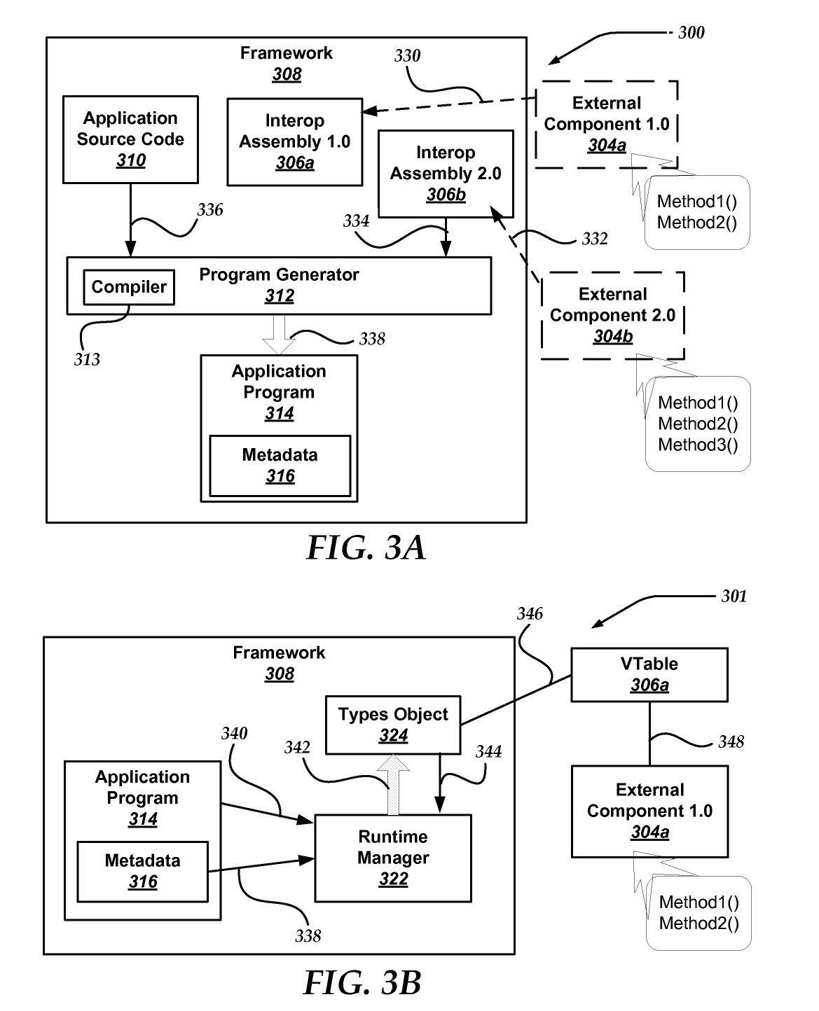

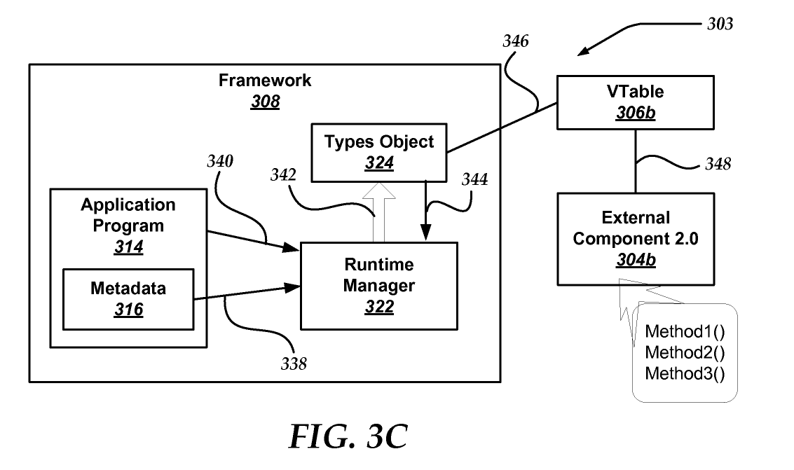

FIG. 3A is a block diagram of a compile-time system 300 having multiple versions of an external component. Each version, for example, may be a version that is updated relative to prior versions. Some versions may not be updates, but may include features or characteristics different from another version. In FIG. 3A, versions of an external component are illustrated as external component 1.0 304a and external component 2.0 304b. As discussed for FIG. 2A, external components 304a-b are not part of the compile-time system 300, but are shown to illustrate their relationships to corresponding interop assemblies. Each external component 1.0 304a-b has a corresponding version of an interop assembly 306a-b. In one embodiment, interfaces of an external component may adhere to a rule that each version of the interface is a superset of previous versions. For example, a new method may be added to the interface, but a method is not deleted. If a method changes such that it requires a change of interface, the old method and interface is left unchanged, and a new method and corresponding interface is added with the desired changes.

FIG. 3A illustrates a compile-time system 300 in which multiple versions of interop objects exist. As illustrated in FIG. 3A, a first version of an external component 1.0 304a includes methods “method1( )” and “method2( ).” A second version of the external component 2.0 304b has both of these methods and an additional method, “method3( ).” Interop assembly 306a has been generated by an external component compiler (not shown) from external component 1.0 304a (as indicated by arrow 330). It has metadata pertaining to “method1( )” and “method2( ).” Interop assembly 306b has been generated by an external component compiler (not shown) from external component 2.0 304b (as indicated by arrow 332). It has metadata pertaining to “method1( ),” “method2( ),” and “method3( )”. Thus, interop assembly 306a and interop assembly 306b each present different external interfaces, and the interface of interop assembly 2.0 306b is a superset of the interface of interop assembly 1.0 306a.

A developer may specify which of the available interfaces are to be used when compiling the application source code 310. During compilation, program generator 312 uses the interop assembly having the specified interface. For example, if a developer has specified that the interface corresponding to interop assembly 306b is to be used (either explicitly or by indicating that the most recent one is to be used), the compilation process may extract metadata (as shown by arrow 334) from interop assembly 306b, in a manner as described in reference to FIG. 2A and elsewhere herein. Program generator 312 also receives as input (as shown by arrow 336) application source code 310. The metadata may then be embedded in the application program 314, generated by program generator 312 (as shown by arrow 338). This enables the application program 314 to execute on a host computer system having external component 2.0 304b or a computer system having external component 1.0 304a, since it has the metadata for referencing either one.

Program generator 312 may be substantially similar to program generator 212 of FIG. 2. As illustrated, program generator 312 includes compiler 313, which may perform various actions of source code translation and code generation as described for program generator 212 and compiler 213 of FIG. 2.

FIG. 3B illustrates a runtime system 301 that may be used to execute application program 314 as generated in the compile-time system 300 of FIG. 3A. In one implementation, runtime manager 322 may retrieve (arrow 338) metadata 316 and generate (arrow 342) types object 324, which enables interaction with external component 1.0 304a or 2.0 304b. During execution, runtime manager 322 receives data (arrow 340) from application program 314, as described in FIG. 2B. It may also retrieve data (arrow 344) from types object 324, such as a pointer to a method in external component 1.0 304a. Types object 324, in turn, may use its references (arrow 346) to vtable 306a and references (arrow 348) from vtable 306a to external component 1.0 304a, to determine pointers into external component 1.0 304a.

In runtime system 301, the host computer system includes external component 1.0 304a and does not include external component 2.0 304b. Application program 314, as compiled with interop assembly 306b in compile-time system 300, will not be enabled to invoke “method3( ).” Application program 314 may handle this by having logic that determines whether the external component that is currently invoked includes “method 3,” and performing actions based on its availability. For example, application program 314 may present a specific feature when executing on a host system in which external component 2.0 304b is active, and not present the feature when executing on a host system in which external component 2.0 304b is not active. A developer of application source code 310 may have documentation that describes differences between the versions, in order to include logic such as this.

FIG. 3C illustrates a runtime system 303 that may be used to execute application program 314 as generated in the compile-time system 300 of FIG. 3A. Like numbered components in FIG. 3C represent like numbered components of FIG. 3B, and the discussion of these components with reference to FIG. 3B applies to FIG. 3C, unless indicated otherwise herein.

In runtime system 303, external component 2.0 304b is deployed on the host computer system, instead of external component 1.0 304a as in FIG. 3C. External component 2.0 304b has a corresponding vtable 306b. External component 2.0 304b implements “method1( ),” “method2( ),” and “method3( ).” Therefore, unlike runtime system 301 of FIG. 3B, application program 314 may invoke “method3( )” in runtime system 303. Thus, FIGS. 3B-C together illustrated that an application program compiled with an interop assembly from a particular version of an external component may execute on a system with a previous version of the external component as well as on a system with the particular version.

Though not illustrated, in one embodiment, an application program may be compiled with an interop assembly from a particular version and execute with an external component of a subsequent version. However, the additions to the interface, as added subsequent to the particular version, will not be available to the application program even though they may be implemented in the newer version.

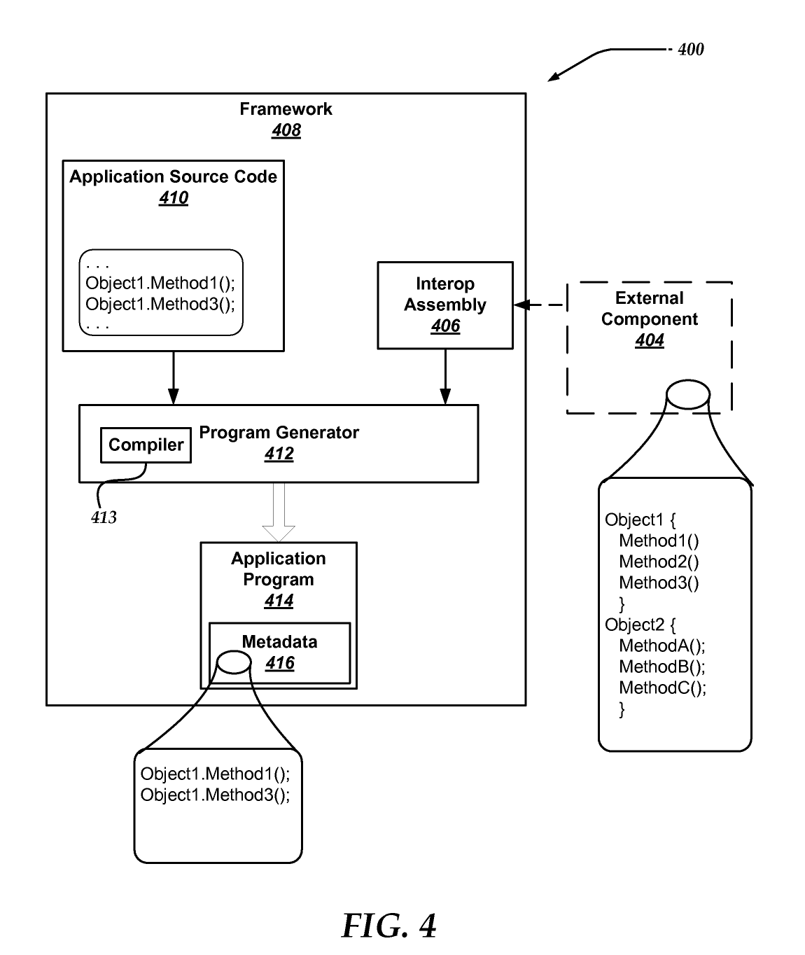

FIG. 4 illustrates components of a compile-time system 400. Mechanisms related to compile-time system 400 are similar to mechanisms as described for FIGS. 2A and 3A, and are only selectively discussed herein. As illustrated, compile-time system 400 includes interop assembly 406, application source code 410, and program generator 412. Program generator 412 receives as input application source code 410 and interop assembly 406, and generates application program 414 with metadata 416 embedded therein. Though not included in compile-time system 400, external component 404 is compiled to generate interop assembly 406.

Program generator 412 may be substantially similar to program generator 212 of FIG. 2. As illustrated, program generator 412 includes compiler 413, which may perform various actions of source code translation and code generation as described for program generator 212 and compiler 213 of FIG. 2.

As illustrated, external component 404 defines object1, having method1( ), method2( ), and method3( ). It further defines object2, having methodA( ) and methodB( ). Metadata corresponding to each of these objects and methods may be included in interop assembly 406.

In one aspect of the mechanisms of compile-time system 400, program generator 412 may determine the methods and types that are referenced, directly or indirectly, by application source code 410. An indirect reference may include, for example, a type that is included within another referenced type. In one implementation, this set of references is the transient closure of references to the external object. This set of references may include types that are used in the signatures of methods that are referenced by application source code 410, such as arguments to the methods or return values. Program generator 412 may then selectively include metadata such as type definitions based on whether the metadata is referenced or otherwise needed to execute application program 414.

In the example illustration of FIG. 4, program generator 412 may determine that a set of referenced metadata includes object1, and methods method1( ) and method3( ) of object1. It may therefore embed metadata corresponding to this object and methods within metadata 416. It may exclude metadata corresponding to method2( ) of object one, as well as metadata corresponding to object2 and its methods. Thus, program generator 412 may automatically determine and embed a partial set of metadata into application program 414. In some configurations, this partial set may be considerably smaller than the complete set of metadata included in interop assembly 406. The partial set may exclude a remaining portion of metadata included in interop assembly 406, the remaining portion including type definitions or other metadata relating to types or methods not referenced by application program 414. During execution, a types object generated from application program 414 and metadata 416 may similarly selectively include metadata based on whether the metadata corresponds to the partial set. In some configurations, this may result in a considerable reduction in the amount of memory used to execute application program 414.

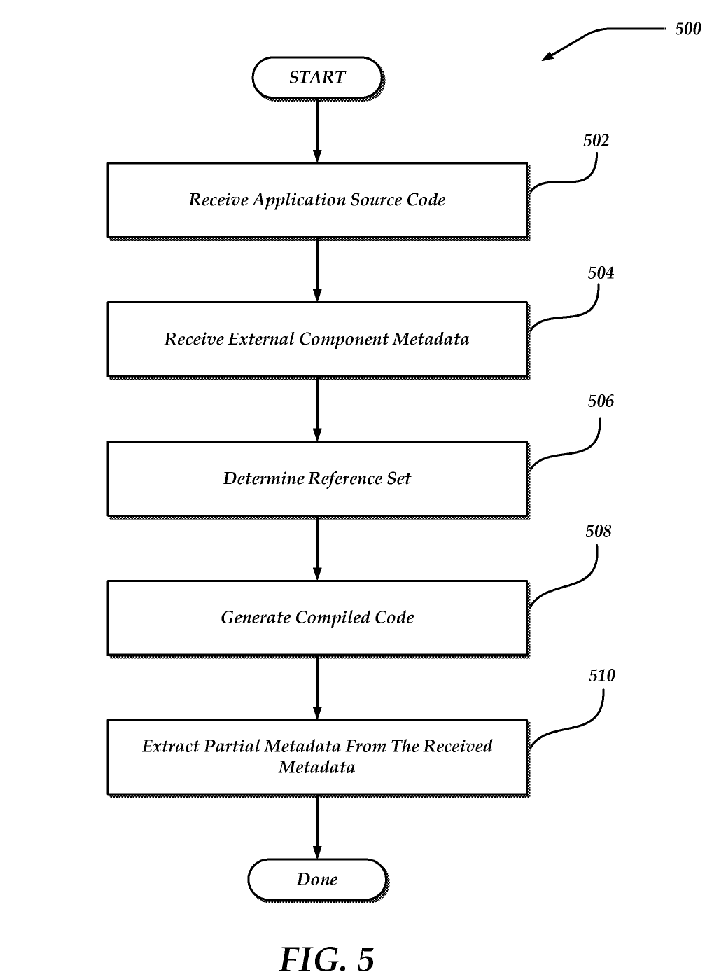

FIG. 5 is a flow diagram illustrating a process 500 of generating an application program that employs one or more external components. Process 500 may be employed in a system in which an application program is a component of a first architecture and the one or more external components are components of a second architecture. Compile-time systems 200, 300, and 400 are examples of such systems, though process 500 may be employed in other systems. In one embodiment, a program generator, such as program generators 212, 312, or 412 of FIGS. 2, 3, or 4 respectively, may perform process 500, or a portion thereof.

Though not illustrated in FIG. 5, in one embodiment, prior to execution of process 500, an interop assembly may be generated. As discussed herein, an interop assembly may be generated by processing an external component.

Process 500 may begin, after a start block, at block 502, where application source code may be received. The application source code may be in the form of one or more files or data objects. The source code may be in any of a variety of computer languages, including low level languages or what is known as intermediate languages.

Process 500 may flow to block 504, where external component metadata may be received. As discussed herein, external component metadata may include typedefs, method signatures, or various other metadata that may be used during compilation or execution of a program that interacts with the external component. In one embodiment, the external component metadata is received from an interop assembly, as illustrated in compile-time systems 200, 300, or 400. It is to be noted that receiving the metadata at block 504 may mean receiving a pointer to the location of an assembly, and actual retrieval and processing of metadata may occur at a later time.

Process 500 may flow to block 506, where a reference set is automatically determined, based on the application source code or a translated representation thereof. More specifically, the reference set may be based on direct or indirect references to the external component. In one embodiment, the reference set may be determined based on the external component metadata. In particular, in one embodiment, references to the external component in the application source code may be selectively included in the reference set, based on whether the references correspond to the received external component metadata. This may represent, for example, methods, objects, types, or other specifications of an external interface corresponding to the external component.

In one embodiment, the application source code or a translated representation thereof is automatically processed to determine a minimal reference set. The minimal reference set may include the transient closure of references to the external component; it may exclude metadata that is not referenced by the application source code. In one embodiment, process 500 may determine a reference set that is substantially a minimal reference set. This may include a relatively small variation from a precise minimal reference set.

Process 500 may flow to block 508, where the application source code may be translated to a lower level code, referred to as compiled code. In various embodiments, the lower level code may be an intermediate language, a machine code, or an interpretable code. In one embodiment, an intermediate language code is further compiled immediately prior to execution. It is to be noted that translation of source code may be performed in one or more steps, and the various steps may be performed at various times during process 500. Some of the steps may be performed prior to process 500 or subsequent to process 500. However, translation is shown in block 508 for illustrative purposes.

Process 500 may flow to block 510, where metadata corresponding to the reference set is extracted from the received external component metadata. The amount of extracted metadata may range from the entire metadata to a very small subset of the metadata. At block 512, the extracted metadata may be combined with the lower level code generated at block 508. This may result in an application program such as application programs 214, 314, or 414, of FIGS. 2-4, respectively. The combination of code and metadata may be performed in a variety of ways, including embedding parts of the metadata at one or more locations within the code, appending the metadata to the code, or the like. The resultant application program may be one or more files or data objects. In one implementation, the metadata and the code may reside in separate files, but be combined in the sense that the combination of files is considered to be an application program.

Process 500 may flow to a done block and return to a calling program.

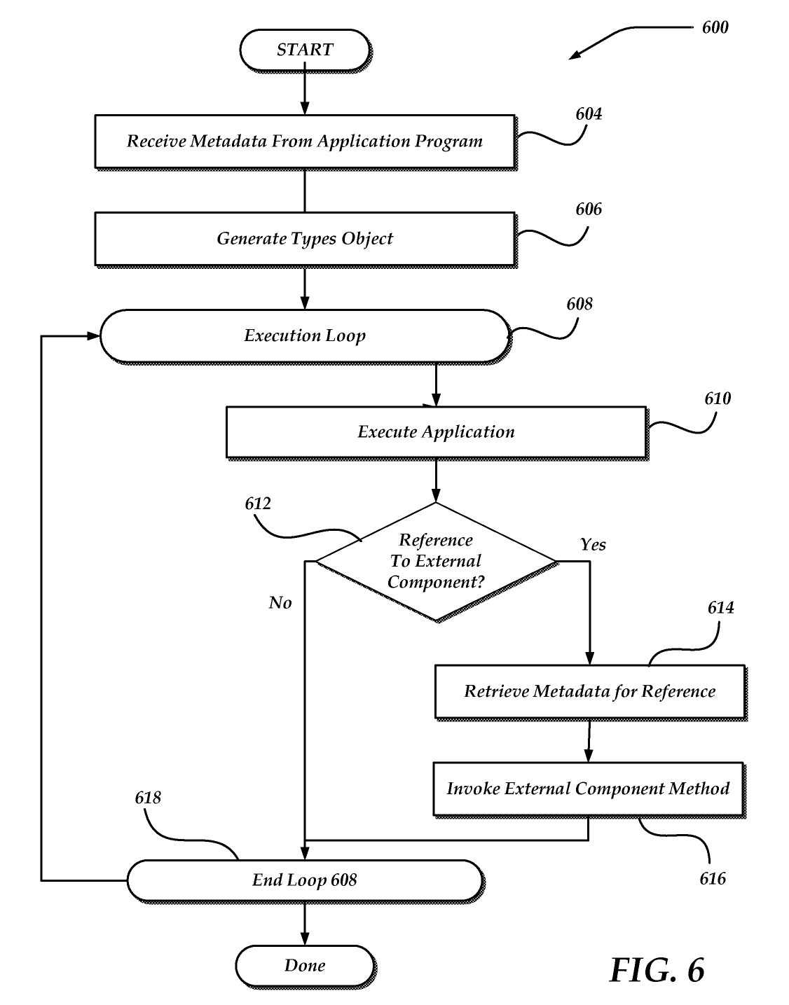

FIG. 6 is a flow diagram illustrating a process 600 of facilitating an interaction of one or more external components with an application program. Process 600 may be employed in a system in which an application program is a component of a first architecture and the one or more external components are components of a second architecture. Runtime systems 201, 301, and 400 are examples of such systems, though process 600 may be employed in other systems. Process 600 may be employed with an application program that is produced as a result of performance of process 500.

Process 600 may begin after it is determined that an application is beginning, or is to begin, execution. This may be the result of a command or signal received from the operating system, from the application itself, or another component.

Process 600 may begin, after a start block, at block 604, where metadata is received from the application program, and specifically from the application executable. The metadata may include type information, location information, or other information that may be used to reference an external component. To clarify the discussion herein, the metadata received from the application program is referred to as application metadata.

Process 600 may flow to block 606, where a types object may be generated. The types object may be based on the application metadata. It may include all, or a portion of the application metadata. In one implementation, it includes a portion of the application metadata that is to be used to enable interaction with the external component. In one implementation, program instructions to facilitate invocation of methods or other interaction with the external component may be included in the types object.

It is to be noted that in a system having multiple application programs, process 600 may be performed for each application program, resulting in a types object corresponding to each application program, wherein differences between the types objects reflect corresponding differences between the application programs.

Process 600 may flow to block 608, where an execution loop begins, referred to herein as loop 608. In the illustration of process 600, blocks 610-616 are included within loop 608. Process 600 may flow to block 610, where a portion of the application program is executed. In various implementations, this may be performed by any of a number of techniques. In one implementation, control may be passed to an operating system to execute the application program until an interrupt, exception, or other change of control occurs. In one implementation, an interpreter may process and execute instructions of the application program. Other techniques may also be used to control execution of the application program.

Process 600 may flow to block 612, where a determination is made of whether a reference to an external component method by the application program is performed. If a reference is not being performed, process may flow to block 618, which terminates loop 610. Logic of loop 610 and its termination block 618 may cause the application program to execute indefinitely, until the program exits. Numerous actions may cause a program exit, including an explicit exit instruction, an exception, an operating system event, or other actions.

If, at block 612, it is determined that a reference to the external component is made, process 600 may flow to block 614, where the corresponding invocation metadata is determined and retrieved. This metadata may include information facilitating determining a location of the method, information facilitating marshalling of arguments, stack manipulation, register handling, or other runtime actions. These actions may include retrieving data from the types object corresponding to the application program. It may include retrieving data from a data structure, such as a vtable, that maintains location data of methods.

Process 600 may flow to block 616, where the referenced method of the external component is invoked. This may include, for example, passing execution control to the method of the external component.

Upon an exit of the external component method, process 600 may flow to block 618. As discussed above, block 618 terminates loop 610, and may cause process 600 to exit when the application program exits.

In one embodiment, in which multiple application programs are executing concurrently, multiple instances of process 600 may be performed, one corresponding to each application program. Each application may have a corresponding types object for each external component.

It will be understood that each block of the flowchart illustrations of FIGS. 5-6, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A computer-implemented method for enabling a computer program in a framework to reference an external component outside of the framework, comprising:
a) compiling source code corresponding to the computer program to generate compiled code;
b) determining a set of metadata corresponding to the external component and the computer program; and
c) retrieving, from an assembly corresponding to the external component, the set of metadata; and
d) generating the computer program by combining the set of metadata and the compiled code so that the metadata is local to the computer program.

2. The method of claim 1, wherein the set of metadata corresponds to a substantially minimal reference set based on the computer program.

3. The method of claim 1, wherein determining the set of metadata comprises determining a set of methods provided by the external component and referenced by the computer program, and determining the set of metadata that corresponds to the set of methods.

4. The method of claim 1, further comprising enabling the computer program to include metadata sufficient to execute in an environment in which the assembly is not deployed.

5. The method of claim 1, further comprising providing a runtime manager component configured to perform actions including retrieving at least a portion of the set of metadata from the computer program; generating a types object with the portion of the set of metadata and program instructions to facilitate invoking the external component; and in response to determining an invocation of the external component, passing control to the types object.

6. The method of claim 1, wherein the framework is a managed framework, the computer program is a managed program, and the external component executes outside of the managed framework.

7. A system in a computing environment for enabling a computer program in a framework to interact with an external component outside of the framework, comprising a program generator configured to perform actions including:
a) extracting metadata relating to the external component and referenced by the computer program, from an assembly that has been generated from the external component, the metadata including type definitions of the external component; and
b) combining the extracted metadata with compiled code of the computer program to generate an application executable in which the extracted metadata has a scope that is local to the computer program.

8. The system of claim 7 further comprising a program translator that translates a source code of the computer program into the compiled code of the computer program and determines a set of methods corresponding to the external component that are referenced by the computer program.

9. The system of claim 7, wherein extracting metadata comprises determining a first portion of metadata residing in the assembly and a remaining portion of metadata residing in the assembly, extracting the first portion, and excluding the remaining portion, the remaining portion comprising metadata corresponding to type definitions of the external component that are not referenced by the computer program.

10. The system of claim 7, wherein the actions further comprise enabling the application executable and external component to execute and interact without the assembly.

11. The system of claim 7, further comprising a runtime manager configured to perform actions including determining an invocation of the external component and employing the extracted metadata to facilitate invocation of the external component by the application executable.

12. The system of claim 7, further comprising a runtime manager configured to perform actions including: in response to execution of the application executable, retrieving at least a portion of the metadata from the application executable; generating a types object with the portion of the extracted metadata; and inserting, into the types object, program instructions for facilitating invocation of methods referenced by the application executable.

13. A computer-based system for enabling a computer program in a framework to interoperate with an external component outside of the framework, comprising:
a) a program translator that translates source code of the computer program to a compiled code; and
b) program generation means for generating an application executable by combining the compiled code with metadata corresponding to methods of the external component that are referenced by the computer program, wherein the combined metadata has a scope that is local to the computer program.

14. The system of claim 13, the program generation means including logic to perform actions including embedding, into the application executable, an interface to the computer program that enables a runtime manager on a target system to extract at least a portion of the metadata from the computer program while the computer program is executing .

15. The system of claim 13, wherein the program translator means determines a set of methods that are referenced by the source code and are not defined in the source code, and the program generation means uses the determined set of methods to determine the metadata that is to be combined.

16. The system of claim 13, the program generation means including logic to extract the metadata from an assembly, and wherein generating the application executable includes enabling the application executable to execute in an environment in which the assembly is not deployed.

17. The system of claim 13, further comprising a runtime management means for enabling the computer program to interoperate with the external component by retrieving the metadata from the computer program and employing the retrieved metadata to invoke a method of the external program.

18. The system of claim 13, further comprising a runtime management means for enabling the computer program to interoperate with a second external component, in which the version of the second external component is different than the version of the external component.

19. The system of claim 13, the program generation means including logic to perform actions including determining the metadata to be a minimal set of metadata based on references to the external component by the computer program.
